(19) United States
(12) Patent Application Publication
(10) Pub. No.: US 2003/0065732 A1
(43) Pub. Date: Apr. 3, 2003

(54) Apparatus for operating a technical device, data processing device and computer program

(76) Inventors: Georg Gortler, Baiersdorf (DE); Wolfgang Herrmann, Herzogenaurach (DE); Detlef Hofmann, Erlangen (DE); Stephan Welsing, Hochstadt (DE)

Correspondence Address: YOUNG & THOMPSON, 745 SOUTH 23RD STREET 2ND FLOOR, ARLINGTON, VA, 22202

(21) Appl. No.: 10/241,517

(22) Filed: Sep. 12, 2002

(30) Foreign Application Priority Data
Sep. 12, 2001 (DE) 10144931.3

(51) Int. Cl. G06F 15/16

(52) U.S. Cl. 709/208

(57) ABSTRACT

The invention relates to an apparatus for operating a technical device, having an operating sequence module and at least one further module with which the operating sequence module communicates. The operating sequence module automatically adapts an execution of an operating control sequence or individual steps to be carried out in order to execute the operating control mode automatically, on the basis of data stored in the further module. The invention also relates to a technical device which has the apparatus, a data processing device by means of which the apparatus can be implemented, and a computer program which implements the apparatus.

The present invention relates to an apparatus for operating a technical device. The invention also relates to a technical device which comprises said apparatus, a data processing device with which said apparatus can be implemented, and a computer program which implements said apparatus.

Technical device is understood as a technical system, for example a conveyor system, or a piece of technical equipment, for example a magnetic resonance device. The term “operate” is to be understood in the widest sense. It comprises in particular initial activation, maintenance and adjustment of the technical device, or determination of a fault should the technical device be faulty.

A fault of a piece of equipment may be determined, for example, using an expert system described in U.S. Pat. No. 4,964,125. The expert system comprises knowledge base based on a model of the piece of equipment. The expert system comprises an evaluation device which forms a diagnosis on the basis of the data stored in the knowledge base and the user entries.

DE 31 12475 A1 discloses a telephone apparatus with an electroacoustic transducer and transmission device, tactile operator control elements, optical display means and electromechanical or electronic switching, control and storage devices. The telephone apparatus has an operator control field whose tactile operator control elements comprise a dialing keypad as well as a small number of additional functional keys, a display panel with an alphanumeric LCD dot display, a control module and an interface module. The interface module be exchanged for adaptation to different telephone networks. It contains a switching device for setting up data connections and telephone connections, and an electroacoustic analog component.

An apparatus for the simplified operator control of a telephone apparatus is described in DE 41 07 745 C1. The apparatus contains a control device, a display apparatus and input keys. By activating the input keys, control operations within the telephone apparatus are triggered. Different functions which can be represented on the display device can also be assigned to the input keys.

Complex technical devices, for example the aforementioned magnetic resonance device, generally comprise a computer and are controlled using computer programs stored in the computer. The computer programs permit, for example, a service technician to carry out measurements on the technical device in a dialog mode, to set internal parameters or to execute other functions, in particular to activate, maintain and adjust the technical device or else determine a cause of a fault if the technical device is subject to a fault. The computer of the technical device can also be constructed in such a way that the service technician can maintain the technical device remotely if the computer can be contacted via, for example, the Internet, a modem or over an ISDN (Integrated Services Digital Network) connection (cf. for example U.S. Pat. No. 6,170,019 B1).

However, the computer programs already mentioned are constructed in such a way that generally only a specially trained person such as the service technician can operate the technical device correctly and efficiently by means of the computer programs.

The object of the invention is therefore to provide conditions for facilitating operator control of the technical device.

The object of the invention is achieved by means of an apparatus for operating a technical device, having an operating sequence module and at least one further module, the operating sequence module being constructed in such a way that it communicates with the further module, an operating control mode can be selected from a list of operating control modes made available by the operating sequence module, an execution of a sequence of the selected operating control mode can be initiated on the basis of the selected operating control mode or individual steps to be executed can be displayed in order to carry out the selected operating control mode, and said operating sequence module automatically adapts the sequence or the steps to be carried out on the basis of data stored in the further module.

The apparatus according to the invention is provided for operating the technical device. Technical device is understood, as already mentioned above, to be a technical system or a piece of technical equipment. A technical system is, for example, a conveyor system, and a piece of technical equipment is, for example, a piece of medical equipment, for example a magnetic resonance device or a computer tomograph. The term “operate” is also to be understood in the widest sense. In particular according to one variant of the invention it comprises initial activation, maintenance and/or adjustment of the technical device. In this way, for example the service technician can carry out measurements, set internal parameters or trigger other functions on the technical device.

The apparatus according to the invention also comprises the operating sequence module which, on the basis of the selected operating control mode, initiates the sequence of the selected operating control mode or displays individual steps for the execution of the selected operating control mode, for example with a computer monitor. The service technician selects the desired operating control mode from the list of operating control modes; if the list comprises, for example, the options initial activation, maintenance and adjustment, the service technician can decide, by means of the list, whether he would like to activate the technical device, perform maintenance on it or else make specific adjustments. After the selection, the operating sequence module initiates the selected operating control mode; if the service technician selects, for example, the option initial activation, the operating sequence module initiates a preferably automated initial activation which is also controlled by the operating sequence module. Instead of initiation, it is, however, also possible for the operating sequence module to display individual steps which are necessary for the initial activation and are to be carried out by the service technician.

The apparatus according to the invention also has the further module with which the operating sequence module communicates. On the basis of the data stored in the further module, the operating sequence module adapts the execution of the selected operating control mode or the displayed steps to be carried out, in particular automatically. The further module is, according to one embodiment of the invention, in particular a configuration module which is embodied in such a way that it makes available data relating to the configuration of the technical device, a user module which is embodied in such a way that it makes available data relating to a user of the apparatus, or a state monitoring module which is constructed in such a way that it senses and makes available data relating to a technical state of the technical device at a particular time.

If the technical device comprises, for example, the configuration module, the operating sequence module adapts the individual displayed steps for the execution of the initial activation, of the maintenance etc. of the technical device in accordance with the configuration of the technical device; i.e. only those steps for the initial activation, maintenance etc. of the technical device which are actually necessary on the basis of the configuration of the technical device are displayed to the service technician. This is particularly advantageous if technical devices of a particular type can, in particular, have a large number of different equipment options which are taken into account in particular when maintenance, adjustment or else initial activation occurs. This ensures that all the necessary steps, but also no unnecessary steps, are displayed to the service technician.

A further example of an adaptation is an execution of a quality measurement on a magnetic resonance device. The quality measurement is used to ensure a high level of quality of MR images which are taken with the magnetic resonance device. To do this, a person who also operates the magnetic resonance device during an examination carried out with the magnetic resonance device, said person being for example a paramedic, generally carries out the quality measurement on, for example, a weekly basis. Within the scope of the maintenance of the magnetic resonance device, the service technician can, however, also carry out a quality measurement which is more detailed than the quality measurement carried out by the paramedic. If the apparatus according to the invention then comprises the user module whose data comprises information relating to the paramedic and the service technician, the operating sequence module of the paramedic displays only the steps for the execution of the weekly quality measurement. On the other hand, the steps of the execution of the more detailed quality measurement are displayed to the service technician.

If the device according to the invention has the state monitoring module, the operating sequence module adapts the sequence of the execution or the displayed steps for the execution of the selected operating control mode to the technical state of the technical device. The state monitoring module can, for example, be constructed in such a way that it stores the times and types of executed maintenance operations. Thus, it is for example possible that the technical device will have to be maintained with different degrees of intensity at particular times. This is the case, for example, if a technical device is, for example, maintained on an annual basis and, in addition to the annual maintenance, additional examinations have to be carried out every two years. The state monitoring module can then be executed in such a way that it detects the execution of the maintenance and, depending on the maintenance already executed, displays only the steps for executing the annual maintenance or else the steps relating to the additional examinations.

According to one particularly preferred embodiment of the invention, the list of operating control modes can also be a list of fault descriptions. The operating control mode of the technical device is then troubleshooting of the technical device. The fault descriptions comprise, in particular, faults which typically occur for a particular technical device. These are, for example, imaging quality problems of MR images which are generated with the magnetic resonance device. The MR images may have, for example, various artifacts such as ring-shaped artifacts or line-shaped artifacts. If such artifacts occur, the magnetic resonance device is either defective or only incorrectly adjusted. While an incorrectly adjusted magnetic resonance device can generally be adjusted by the paramedic himself using the operating sequence module, a defective magnetic resonance device can only be repaired by the service technician. For this reason, the operating sequence module displays different steps during the troubleshooting carried out by the paramedic from those displayed during troubleshooting carried out by the service technician. The troubleshooting steps are, for example, tests which are to be carried out specially.

The tests to be carried out can also be dependent on the configuration of the magnetic resonance device. The operating sequence module therefore readapts the sequence of the selected operating control mode or the displayed steps for the execution of the selected operating control mode on the basis of the data stored in the further module.

During the operating control mode, in particular during the execution of the tests, it is helpful if, as is provided according to a further variant of the invention, the operating sequence module is additionally constructed in such a way that during the sequence of the selected operating control mode it is possible to display instructions to a person carrying out the operating control mode, the displayed instructions being automatically adapted on the basis of the data of the further module. In the case of the magnetic resonance device it is, for example, conceivable for the paramedic to be provided with more detailed instructions, for example in the form of help during the troubleshooting. An experienced service technician on the other hand requires fewer instructions for the troubleshooting so that the instructions for him may be less detailed.

According to a further variant of the invention, the apparatus additionally comprises a result module which is constructed in such a way that data which is determined during the execution of the operating control mode can be stored by means of the result module, and in which the result module and the operating sequence module are constructed in such a way that they communicate with one another. Data determined, for example, during the maintenance or the initial activation are stored in the result module. On the basis of a further variant of the invention according to which the apparatus has a report module which is constructed in such a way that a selection of the data of the result module can be displayed on the basis of data stored in the user module, it is possible, for example, for results determined on the basis of a maintenance operation to be displayed with different degrees of detail depending on the user.

If, according to a further variant of the invention, the data which is determined and stored in the result module can be transferred over a data transmission network, it is possible, in particular, for results of a maintenance operation to be stored and evaluated centrally. The data transmission network is, for example, the Internet or a telephone network to which the apparatus according to the invention is connected via a modem. The data transmission network may, however, also be an ISDN network to which the apparatus according to the invention is connected.

According to a further embodiment of the invention, the data is XML (extended markup language) data. The XML data format is a database format. In this way, data maintenance is made easier as the data is separated from its representative interface. On the basis of the XML data format, the interfaces can be predefined and are thus communal. Expansion with further modules or expansion of the modules is consequently also easily possible, also making maintenance of the data or of the individual modules easier.

The object of the invention is also achieved by means of a technical device which has the apparatus according to the invention described above. The object is also achieved by means of a data processing device by means of which the apparatus according to the invention which is described above can be implemented. In addition, the object is achieved by means of a computer program which implements the apparatus according to the invention. According to one variant of the invention, the technical device is in particular a medical device.

Modern technical devices generally comprise a computer in which suitable computer programs which suitably control the technical device during operation are stored. The computer can be constructed according to the invention in such a way that it is used to implement the apparatus according to the invention.

By means of the apparatus according to the invention, and in particular the computer program according to the invention, a workflow-oriented or problem-oriented procedure is therefore made possible for the operator control of the technical device. The user of the technical device is prompted, for example when there is a change in the configuration or when a module of the technical device is replaced, by means of necessary steps to be carried out. If, for example, the service technician would like to adapt a host name of the computer of the technical device, he calls the “configuration” option. All the steps necessary for the configuration of the computer, for example an adaptation of a database of the computer, are carried out automatically by the computer program according to the invention or displayed so that the service technician can adapt a system structure of the computer.

If the user is provided with the list of fault descriptions, the respective maintain functions are, for example, started at the correct time. In addition, it is possible to intersperse the documentation and computer program. The documentation can be started from the computer program. The computer program can also be started from the documentation. In particular if the data is XML data, it is possible to transmit the data without difficulty over the Internet or Intranet. There is also no need to take into account any particular firewalls. New modules can be inserted using simple standard tools, for example by means of cut and paste.

An exemplary embodiment is represented by way of example in the following schematic figures, of which:

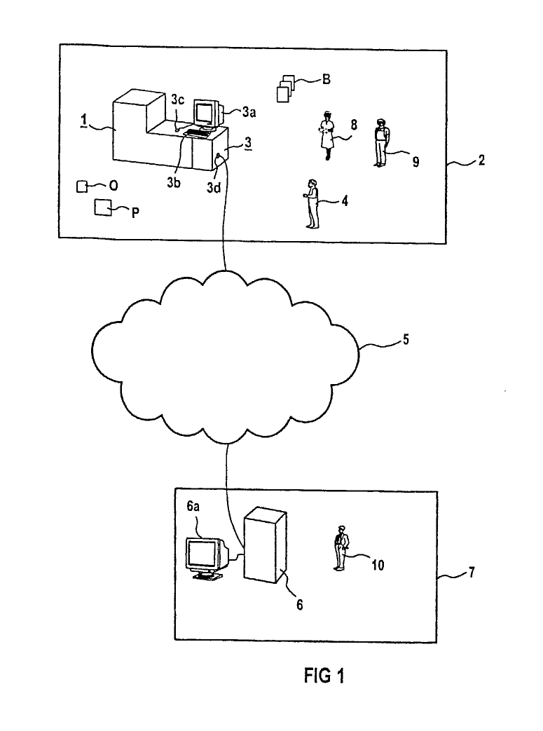

FIG. 1 shows a magnetic resonance device,

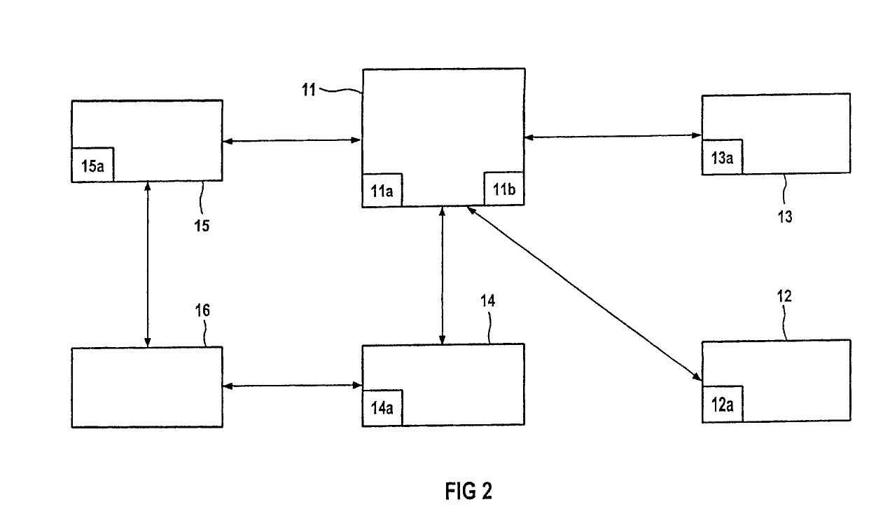

FIG. 2 is a diagram of the apparatus according to the invention,

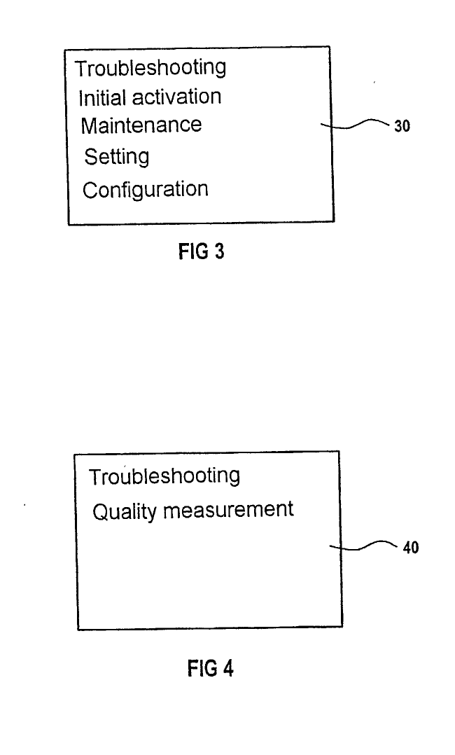

FIGS. 3 to 5 are operator interfaces,

FIG. 6 is a window, and

FIG. 7 is a further operator interface.

FIG. 1 shows a magnetic resonance device 1 which is located in a doctor's practice 2. The magnetic resonance device 1 comprises a computer 3 comprising a monitor 3a, a keypad 3b and a computer mouse 3c, said computer 3 controlling the magnetic resonance device 1 with computer programs while a patient 4 is being examined, said computer programs being stored in the computer 3 and being familiar to the person skilled in the art. The computer 3 is also provided, in the present exemplary embodiment, with an ISDN connection 3d, with which the computer 3 is connected to an ISDN network 5 so that the computer 3 can in particular communicate with a database 6 which is also connected to the ISDN network 5. This in particular makes it possible for the magnetic resonance device 1 also to be maintained remotely, or for data to be transmitted from the computer 3 to the database 6. In the present exemplary embodiment, the database 6 is located in a room 7 on the premises of the manufacturer of the magnetic resonance device 1.

In the present exemplary embodiment, a further computer program with which the magnetic resonance device 1 can be activated, maintained and set is stored in the computer 3; this computer program, which is referred to as service software, also supports a troubleshooting feature. In the present exemplary embodiment, the service software has a structure illustrated in FIG. 2.

The service software comprises an operating sequence module 11, a configuration module 12, a state monitoring module 13, a user module 14, a result module 15 and a report module 16.

The configuration module 12 is embodied in such a way that it makes available data relating to a configuration of the magnetic resonance device 1. This data is stored in a database 12a assigned to the configuration module 12, and said data comprises in particular information relating to special measuring programs which are stored in the computer 3 and have the purpose of carrying out examinations with the magnetic resonance device 1, and information relating to special equipment levels of the magnetic resonance device 1, for example for measuring or operator control interface coils with which the person skilled in the art is familiar, for example the interface coil O which is shown schematically in FIG. 1.

The state monitoring module 13 is constructed in such a way that it senses, inter alia, a technical state of the magnetic resonance device 1. The technical state of the magnetic resonance device 1 also comprises information relating to tests which have been carried out or are to be carried out and which are carried out in particular during a maintenance operation of the magnetic resonance device 1. In the present exemplary embodiment, this information is stored in a database 13a assigned to the state monitoring module 13.

The user module 14 is constructed in such a way that it makes available information relating to a user of the magnetic resonance device 1. In the present exemplary embodiment, the users of the magnetic resonance device 1 are essentially a paramedic 8 who operates the magnetic resonance device 1 during an examination of the patient 4, and a service technician 9 who initially activated the magnetic resonance device 1, performs regular maintenance on it and if necessary also repairs it. This information is stored in a database 14a assigned to the user module 14.

The result module 15 is constructed in such a way that results which have come about during an initial activation, setting, maintenance or troubleshooting are stored in a database 15a which is assigned to the result module 15.

The report module 16 is constructed in such a way that a selection of the data of the database 15a assigned to the result module 15 is represented on the monitor 3a of the magnetic resonance device 1 on the basis of information stored in the database 14a of the user module 14. In the present exemplary embodiment, the service technician 9 can access all data stored in the database 15a. However, only some of the data is made available to the paramedic 8 as he is not authorized to carry out repairs to the magnetic resonance device 1 or to change the configuration of the magnetic resonance device 1 as this has to be carried out by the specially trained service technician 9.

Furthermore, it is possible to make contact with the computer 3 using the database 6 of the manufacturer of the magnetic resonance device 1 so that the data stored in the database 15a of the result module 15 is transferred to the database 6 of the manufacturer of the magnetic resonance device 1. In the present exemplary embodiment, all the data stored in the database 15a of the result module 15 is also transferred to the database 6 of the manufacturer of the magnetic resonance device 1. The data transferred to the database 6 of the manufacturer can then be represented with a monitor 6a connected to the database 6 and evaluated by an employee 10 of the manufacturer of the magnetic resonance device 1.

So that the correct part of that data which is stored in the database 15a of the result module 15 is selected, the report module 16, the result module 15 and the user module 14 are constructed in such a way that they can communicate with one another. This is indicated by double arrows in FIG. 2.

In the present exemplary embodiment, the object of the operating sequence module 11 of the service software is to control the initial activation, maintenance, setting, such as is carried out for example within the scope of a quality measurement, the configuration of the computer 3 of the magnetic resonance device 1 and troubleshooting. In the present exemplary embodiment, data which is necessary to control these operating control modes is stored in a workflow database 11a which is assigned to the operating sequence module 11. In a database 11b which is assigned to the operating sequence module 11, information is also stored which can be called by a user of the magnetic resonance device 1 during operation so that he is provided with explanations of the operator control of the magnetic resonance device 1 on the monitor 3a. The data which is stored in the database 11b is therefore suitable for helping the user. Furthermore, the operating sequence module 11 is constructed in such a way that it adapts the operator control of the magnetic resonance device 1 to the current user, that is to say either to the paramedic 8 or the service technician 9, to the technical state and to the configuration of the magnetic resonance device 1. For this purpose, the operating sequence module 11, the user module 14, the state monitoring module 13 and the configuration module 12 are constructed in such a way that the operating sequence module 11 can communicate with the user module 14, the state monitoring module 13 and the configuration module 12. This is indicated by appropriate double arrows in FIG. 2.

So that the operating sequence module 11 of the service software can adapt the sequence of the operator control to the current user, the current user must verify his access authorization in the form of an identification code to be input with the keypad 3b of the computer 3.

When the service technician 9 then uses the magnetic resonance device 1 with the service software, an operator interface 30 (shown in FIG. 3) is then set up on the monitor 3a of the computer 3 after he has confirmed his access authorization with the identification code assigned to him. Using the operator interface 30, the service technician 9 can select operating control modes provided for him. These operating control modes are, in the present exemplary embodiment, initial activation, maintenance, setting, configuration and troubleshooting. The service technician 9 can select the operating control mode desired by him by using the computer mouse 3c to click on the respective term of the operator interface 30 in a generally known way.

On the other hand, if the paramedic 8 controls the magnetic resonance device 1 with the service software, an operator interface 40 which is shown in FIG. 4 is set up on the monitor 3b after the paramedic 8 has input his identification code assigned to him. The paramedic 8 can use the operator control interface 40 to select operating control modes provided for him. These operating control modes are, in the present exemplary embodiment, quality measurement which is carried out regularly by the paramedic 8 in order to ensure a high quality of MR images produced with the magnetic resonance device 1, and troubleshooting. The paramedic 8 can select the operating control mode desired by him by using the computer mouse 3c to click on the respective term of the operator interface 40 in a generally known way.

In the present exemplary embodiment, MR images B produced with the magnetic resonance device 1 have quality problems in the form of ring-shaped artifacts. A cause of the quality problems is, for example, an incorrectly adjusted or defective magnetic resonance device 1. If the cause of the fault is an incorrectly adjusted magnetic resonance device 1, the paramedic 8 can determine the cause of the fault by means of the service software itself and possibly eliminate it himself by means of the service software; however, if the cause of the fault is a defective magnetic resonance device 1, the service technician 9 must determine the cause of the fault and remedy the fault.

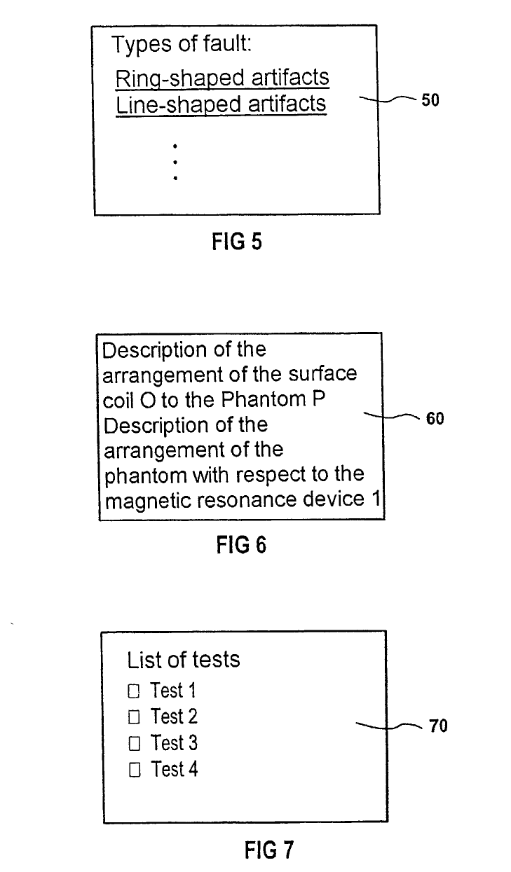

After the paramedic 8 has detected the quality problems of the MR images 8, he activates the service software and confirms his access authorization, in response to which the operator interface 40 shown in FIG. 40 appears on the monitor 3a. He then clicks on the term “troubleshooting” using the computer mouse 3c, in response to which an operator interface 50 illustrated in FIG. 5 appears on the monitor 3a. The operator interface 50 is, in the present exemplary embodiment, a list of fault descriptions which, owing to data stored in the database 14a of the user module 14, has only fault descriptions whose cause the paramedic 8 can remedy. The service software is therefore constructed in such a way that it adapts the list of fault descriptions to the user of the magnetic resonance device 1. As the MR images B have ring-shaped artifacts, the paramedic 8 clicks on the term “ring-shaped artifacts”.

As already mentioned, the paramedic 8 can remedy the cause of the ring-shaped artifacts only if the magnetic resonance device 1 is incorrectly adjusted. On the basis of the data stored in the database 14a of the user module 14 and the data stored in the workflow database 11a, the operating sequence module 11 automatically carries out adjustment of the magnetic resonance device 1. During the adjustment, the operating sequence module 11 automatically carries out measurements using the magnetic resonance device 1. In the present exemplary embodiment 1, a phantom P which is familiar to the person skilled in the art and illustrated schematically in FIG. 1 is provided with the interface coil O for these measurements and arranged on the magnetic resonance device 1. Depending on the configuration of the magnetic resonance device 1, the magnetic resonance device 1 can be equipped with different interface coils. The interface coil with which the magnetic resonance device 1 is equipped is stored in the database 12a assigned to the configuration module 12.

The operating sequence module 11 can communicate with the configuration module 12. For this reason, it uses data stored in the database 11b of the sequence module 11 to generate a window 60 which appears on the monitor 3a of the computer 3, is illustrated in FIG. 6 and comprises a description for applying precisely the interface coil O to the phantom P, and an instruction for the arrangement of the phantom P on the magnetic resonance device 1, as soon as the paramedic 8 is intended to arrange the interface coil O on the phantom P.

After the paramedic 8 has arranged the phantom P provided with the interface coil O on the magnetic resonance device 1, the operating sequence module 11 terminates the measuring sequence by readjusting the magnetic resonance device 1, creates MR images of the phantom P and examines the MR images for artifacts. Data which is assigned to the result of the measuring sequence is then stored in the database 14a assigned to the result module 14. In addition, information relating to the executed measuring sequence is stored in the database 13a assigned to the state monitoring module 13.

In the present exemplary embodiment, the fault cannot be remedied by adjusting the magnetic resonance device 1. For this reason, the report module 16 generates a message which is assigned to the paramedic 8 and tells him to inform the service technician 9.

After the paramedic 8 has informed the service technician 9, he calls the service software of the magnetic resonance device 1 and confirms his access authorization. Then, the operator interface 30 illustrated in FIG. 3 appears. Subsequently, the service technician 9 clicks on the “troubleshooting” term. On the basis of the data stored in the database 13a which is assigned to the state monitoring module 13 and data stored in the database 15a which is assigned to the result module 15, the operating sequence module 11 detects that the “ring-shaped artifacts” fault is present and that a troubleshooting adjustment has already been carried out without success. Then, the operating sequence module 11 generates, on the basis of data stored in the workflow database 11a, an operator interface 70 which is illustrated in FIG. 7 and which appears on the monitor 3a. The operator interface 70 comprises a list of tests which the service technician 9 is to carry out in order to determine the troubleshooting. Then, the service technician 9 can carry out the individual tests in succession, the operating sequence module 11 of the service software controlling the execution of the tests and if necessary generating further windows which comprise descriptions for carrying out the tests. Data which is assigned to the results of the tests is in turn stored in the database 15a assigned to the result module 15.

After the tests have been carried out, the service technician 9 evaluates data which is stored in the database 15a of the result module 15, and then remedies the cause of the fault which was, in the present exemplary embodiment, a defective assembly of the magnetic resonance device 1.

The data stored in the workflow database 11a and the databases 11b, 12a, 13a, 14a and 15a is XML (extended markup language) data in the present exemplary embodiment. As the XML data format is a database format, the data stored in the workflow database 11a and the databases 11b, 12a, 13a, 14a and 15a can easily be expanded. In addition, this data can thus be separated from the operator interfaces 30, 40, 50 and 70 and the window 60. The operator interfaces 30, 40, 50 and 70 and the window 60 are also communal.

For the rest, the exemplary embodiment described is only of an exemplary nature. Other operating control modes can also be carried out. In particular, a technical device other than the magnetic resonance device 1 can also be used.

1. An apparatus for operating a technical device, having an operating sequence module and at least one further module, the operating sequence module being constructed in such a way that
it communicates with the further module,
an operating control mode can be selected from a list of operating control modes made available by the operating sequence module,
on the basis of the selected operating control mode it is possible to initiate execution of a sequence of the selected operating control mode or individual steps which are to be carried out in order to execute the selected operating control mode can be displayed, and
it automatically adapts the sequence or the steps to be carried out on the basis of data stored in the further module.

2. The apparatus as claimed in claim 1, in which the operating control mode is an initial activation, maintenance and/or adjustment of the technical device.

3. The apparatus as claimed in claim 1 or 2, in which the further module is a configuration module which is embodied in such a way that it makes available data relating to the configuration of the technical device, a user module which is embodied in such way that it makes available data relating to a user of the apparatus, or a state monitoring module which is constructed in such a way that it senses and makes available data relating to a technical state of the technical device at a particular time.

4. The apparatus as claimed in one of claims 1 to 3, in which the operating control mode of the technical device is troubleshooting and the list of operating control modes is a list of fault descriptions.

5. The apparatus as claimed in one of claims 1 to 4, in which the operating sequence module is additionally constructed in such a way that during the sequence of the selected operating control mode it is possible to display instructions to a person carrying out the operating control mode, the displayed instructions being automatically adapted on the basis of the data of the further module.

6. The apparatus as claimed in one of claims 1 to 5, which additionally comprises a result module which is constructed in such a way that data which is determined during the execution of the operating control mode can be stored by means of the result module, and in which the result module and the operating sequence module are constructed in such a way that they communicate with one another.

7. The apparatus as claimed in claim 6, which has a report module which is constructed in such a way that a selection of the data of the result module can be displayed on the basis of data stored in the user module.

8. The apparatus as claimed in claim 6 or 7, in which the data which is determined and stored in the result module can be transferred over a data transmission network.

9. The apparatus as claimed in one of claims 1 to 8, in which the data is XML (extended markup language) data.

10. A technical device which has an apparatus as claimed in one of claims 1 to 9.

11. The technical device as claimed in claim 10 which has a medical device.

12. A data processing device by means of which an apparatus as claimed in one of claims 1 to 9 can be implemented.

13. A computer program which implements an apparatus as claimed in one of claims 1 to 9.
